(19) United States
(12) Patent Application Publication
(10) Pub. No.: US 2020/0158242 A1
(43) Pub. Date: May 21, 2020

(54) SEAL DEVICE HAVING CAVITIES

(71) Applicant: NIDEC GPM GMBH, Auengrund OT Merbelsrod (DE)

(72) Inventors: Marcel BERNER, Hildburghausen (DE); Paul LUDWIG, Erfurt (DE); Sebastian EGERMEIER, Hildburghausen (DE); Florian HOFFMANN, Schwarzbach (DE)

(73) Assignee: NIDEC GPM GMBH, Auengrund OT Merbelsrod (DE)

(21) Appl. No.: 16/628,501

(22) PCT Filed: Jul. 9, 2018
(86) PCT No.: PCT/EP2018/068546

§ 371 Date: Jan. 3, 2020

(30) Foreign Application Priority Data
Jul. 21, 2017 (DE) 10 2017 116 535.5

(51) Int. Cl. F16J 15/324; F16J 15/34; F16J 15/16

(52) U.S. Cl. CPC F16J 15/324; F16J 15/162; F16J 15/3412

(57) ABSTRACT

The invention relates to a seal device for hydraulically sealing off sealing faces of components which are movable relative to each other in a translational or rotational relative movement, said device having a tough, elastic sealing device seal body (1) with at least one sliding face (10) which is assigned to at least one sealing face of one of the components, a plurality of cavities (2; 2a, 2b; 22) being formed in the at least one sliding face (10), said cavities having closed contours which are delimited from one another towards the sliding face (10). The contours of the cavities (2; 2a, 2b; 22) have a longer dimension (x) in a contour longitudinal direction (X) and a shorter dimension (y) in a contour transverse direction (Y).

The present invention relates to a sealing device for hydraulically sealing surfaces on components.

In the related art, seals are known which, for example, seal a shaft or a piston in a housing against a liquid while rotating or moving linearly.

Frictional forces of stiction and sliding friction, which are higher in a dry state and decrease in a state where the surfaces are wet with a liquid, occur between a sliding surface of the seal and a surface to be sealed of the component or machine part. It is known to provide recessed cavities at seals in which an operating liquid accumulates. Such lubrication pockets that receive the operating liquid release a part of the accumulated operating liquid when under a suitably aligned pressure, thereby generating a hydrostatic lubricating film between the surfaces as a dynamic seal. Subsequently, the lubricating film accumulates again in the cavities during a static sealing.

The cavities furthermore lead to an overall surface of the surface contact between the seal and the surface to be sealed being decreased, whereby an adhesion component of the frictional force is lowered. As a result, the stiction and sliding friction between the seal and the machine part may be lowered.

In addition, a sealing effect may be improved because an operating liquid must pass through sections, with pressure differences lying in between, via a sealing stretch from one end to the other end of a seal, or rather, between sealing lips.

A sealing body, preferably a sealing collar with micro-grooves, is known from DE 101 20 403 B4. In one implementation as a sealing collar, said sealing body comprises radially circulating micro-grooves that extend beyond an end section of a sealing lip and that seal a gap between two adjacent surfaces of components against a liquid or gaseous medium. The micro-grooves increase anti-friction properties by lowering frictional forces as a function of the pressure resulting from a movement. Stiction and sliding friction are thereby lowered and the level of stiction approaches the level of sliding friction.

EP 1 611 380 B1 discloses a sealing arrangement based on a grooved ring-rod seal which has an improved wear resistance. A dependent, alternative aspect describes that microstructures in the shape of spherical calottes or spherical caps improving anti-friction properties of the U-cup at the rod may be arranged at an inner surface. No further structural details regarding the provision of microstructures with spherical calottes are apparent therefrom.

However, in a structure with circulating micro-grooves, the capacity of building up hydrostatic pressure for the lubricating film is susceptible to damage, such as scratches, which may be caused between contact surfaces at the micro-grooves by impurity particles from the surrounding operating liquid. A local leakage site at any position, such as a scratch or a cut running widthwise through adjacent grooves, thus causes the overall pressure to fall in each concerned groove. As a result, no hydrostatic lubricating film is generated in the surrounding area of affected grooves, and frictional forces may increase.

On the other hand, the mentioned structure with spherical calottes has the disadvantage that it has a fixed ratio of a recessed surface of a cavity to a depth of the cavity. Therefore, the structure with spherical calottes may have a ratio of a proportion of raised and recessed surface sections to depth of the cavities which is unfavourable for a specific application.

Therefore, it is an object of the present invention to provide a sealing device with cavities of which the pressurisation of a hydrostatic lubricating film is more resistant against local damage, particularly scratches caused by impurity particles.

Another object of the present invention is to provide a sealing device with cavities, the structure of which allows an optimization for the application with regard to a surface ratio of raised and recessed sections to depth.

The objects are solved by a sealing device having the features of claim 1.

The inventive sealing device for hydraulically sealing surfaces on components is particularly characterized by the fact that the contours of the cavities have a longer dimension in a contour longitudinal direction and a shorter dimension in a contour transverse direction.

The present invention provides, for the first time, a sealing device as a hydraulic seal which allows a geometric optimisation for the application with respect to raised areas, recessed areas and a recess depth, and of which the capacity of building up hydrostatic pressure across an entire contact surface is relatively resistant to local scratches and across adjacent cavities. An effective and durable functionality of providing a hydrostatic lubricating film may thus be advantageously ensured.

Furthermore, the dimensioning of the longer dimension and the shorter dimension of the respective contours allows an application-specific relative movement direction to be improved. Compared to a structure with spherical calottes, it is thus possible to set the sliding properties between the sealing device and a surface to be sealed as a function of the direction.

Advantageous further embodiments of the invention are the object of the dependent claims.

According to one aspect of the invention, the cavities may have an elliptic contour.

Compared to a spherical calotte, the elliptic shape of the cavity achieves improved reception of particulate matter in case the operating liquid is contaminated, as there is a larger extension transverse to the relative movement direction. Compared to a groove structure, the closed contours of the elliptical cavities nevertheless ensure a reliable build-up of a hydrostatic lubricating film in case of a displacement between the sealing body and a component, or a scratch in one of those two friction counterparts.

According to one aspect of the invention, the cavities may be aligned in the direction of the relative movement of one of the components in relation to the contour transverse direction.

By aligning the shorter dimension in the direction of the relative movement, the structure is made more sensitive. Furthermore, a response of a hydrostatic pressurisation is increased due to a steeper incline of adjoining ridges that incline further under the influence of a relative movement.

According to one aspect of the invention, cavities adjacent to one another in the contour transverse direction may be configured to be offset from one another in the sliding surface in the contour longitudinal direction.

An offset arrangement increases the density of cavities per surface, i.e. a surface ratio of recessed surfaces to unprocessed, raised surfaces. At the same time, combined with the elliptical contour, a greater intersection of the cavities may be provided in the direction of movement, which further reduces the occurrence of dry-running areas of the sliding surface of the sealing body. Furthermore, by offsetting adjacent cavities, the stability of the structure, i.e., of the raised, ridge-shaped surface portions of the sliding surface in a central part in contour longitudinal direction is increased.

According to one aspect of the invention, the sealing body may have a rotationally symmetric shape, and the at least one sliding surface may form a lateral surface of the sealing body.

In this way, an inventive sealing device for rotatory relative movement between components may be realized. A sealing sleeve for translatory relative movement between components, for example a housing and a piston, may also be realized.

According to one aspect of the invention, all cavities may have a common contour longitudinal direction extending in a spiral shape in relation to a centre axis of the rotationally symmetric sealing body.

This arrangement of the cavities may maximize a surface ratio of recessed surfaces to unprocessed sliding surfaces when the cavity transverse direction has a fixed dimension.

According to an alternative aspect of the invention, a plurality of radially circulating contour longitudinal directions may be provided along a centre axis of the rotationally symmetric sealing body, and the cavities may be distributed radially along the contour longitudinal directions.

This arrangement of cavities may also maximise the surface ratio of recessed surfaces to unprocessed sliding surfaces.

According to another aspect of the invention, the cavities may differ from one another with respect to the alignment of the contour.

The alignments of the contours in the elliptical cavities as a whole allows, for example, improved wear to non-linear movements or a dampening of resonances to speed-dependent vibration stimulations that result from an adhesion component and a hysteresis component of the frictional forces, as will be explained later.

According to one aspect of the invention, the sealing device may have at least two different groups of cavities with the same alignment of the contour.

Reducing a variety of selected alignments of the contours of the cavities as a whole reduces the complexity of the structural pattern and of the manufacturing of the sealing device or of a corresponding mould for a moulding process.

According to one aspect of the invention, the cavities may differ from one another in relation to the dimension of the contour.

By using different sizes and corresponding depths of the cavities, a wear process or size of a remaining sliding surface in relation to a wear depth at a sealing body may be realised. A primary wear phase with intact, smaller cavities up to a smaller depth as well as a secondary wear phase with emergency running capacity due to remaining, deeper portions of larger cavities may thus be provided.

In addition, by providing cavities in different sizes, the resulting behaviour of hydrostatic pressurization at a change in direction or at a speed range of the relative movement may be precisely influenced and set with respect to stiction or sliding friction.

According to one aspect of the invention, the sealing device may have at least two different groups of cavities with the same dimension of the contour.

Reducing a variety of selected sizes of the contours reduces the complexity of the structural pattern and of the manufacturing of the sealing device or a corresponding mould for a moulding process.

According to one aspect of the invention, the cavities may have a depth of 10 to 40 μm with respect to the sliding surface.

Within the mentioned range, the depths of the cavities may be advantageously set such that there is capillary action for different fields of application, particularly different liquid mediums.

According to one aspect of the invention, the shorter dimension in the contour transverse direction of the cavities may have a maximum dimension of 15 to 200 μm.

Within the mentioned range, the trigger behaviour of a hydrostatic lubricating film due to the received volume may also be set in an optimised manner.

According to one aspect of the invention, a ratio of the longer dimension in the contour longitudinal direction to the shorter dimension in the contour transverse direction may be a value of 3 to 6.

According to one aspect of the invention, the contours of the cavities may be rounded at a transitional edge to the sliding surface. Such a round shape between the cavities and the sliding surface is advantageous for both the sliding behaviour in load cases as well as when removing the sealing body from the mould during the manufacturing process.

In this range of dimension ratios, preferred dynamic sealing properties with regard to an application-oriented range of surface roughness and sliding speed were determined by means of simulations and testing.

The invention is explained in more detail below with reference to exemplary embodiments in the accompanying figures. They show:

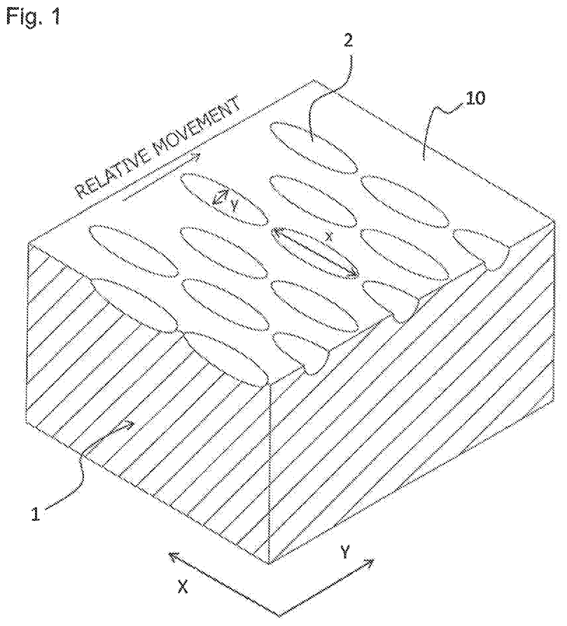

FIG. 1 a structural pattern with cavities offset from one another that form an elliptical contour to the sliding surface of the sealing body;

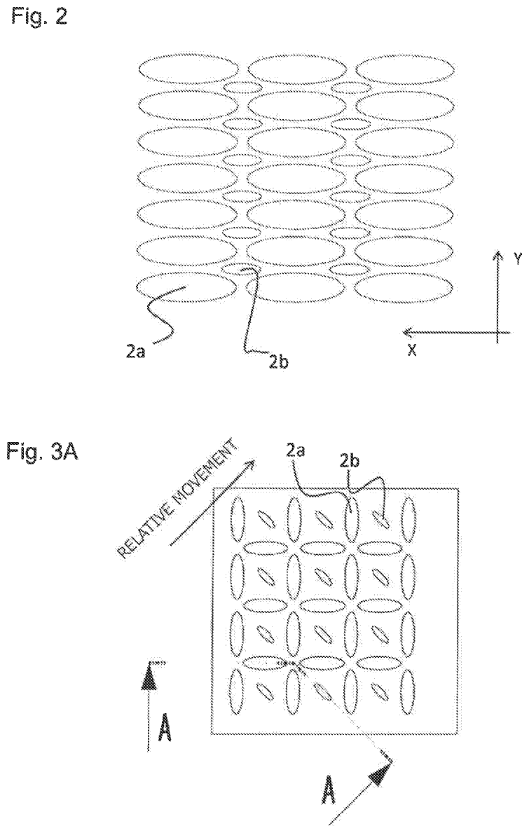

FIG. 2 a structural pattern with a regular arrangement of two groups of elliptical cavities of different sizes;

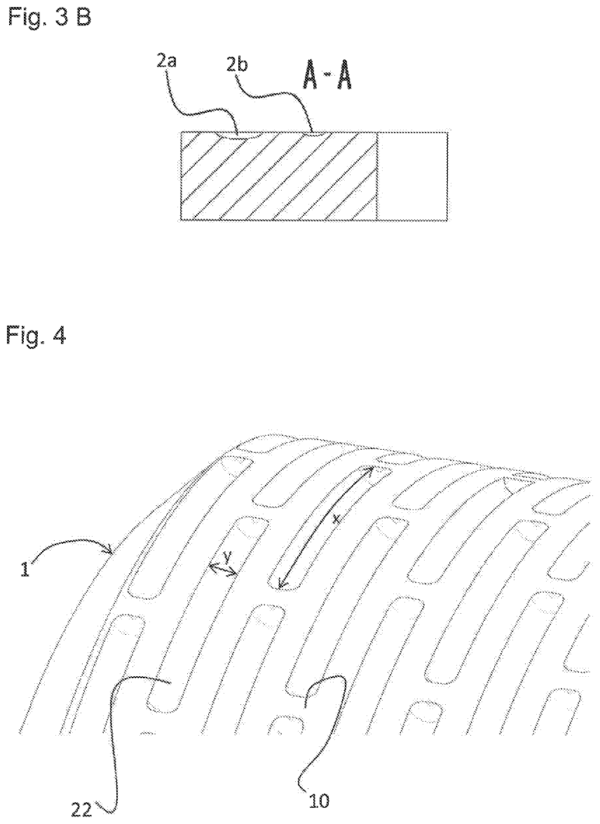

FIG. 3A a structural pattern of cavities with differently aligned contours and different sizes shown in a cross-sectional plan view;

FIG. 3B a cross-sectional view taken along the line A-A of the structural pattern of FIG. 3A; and

FIG. 4 a structural pattern on a rotationally symmetric sealing body in which all cavities are either arranged along a common, spiral-shaped contour longitudinal direction or in parallel vertically to a centre axis of the sealing body.

Below, a first embodiment of the sealing device is described with reference to FIG. 1.

Typically, the inventive sealing device seals a gap between two components that are moveable relative to each other, e.g., a piston or a shaft and a through-opening, against leakage of a liquid. In the present disclosure, a sealing surface is to mean a surface of a component at which a seal is intended to be provided and which, for this purpose, faces the sealing device and is assigned thereto.

FIG. 1 shows a section of a sealing body 1 in a cutaway view. The sealing body 1 comprises a sliding surface 10 which is brought into contact with a surface to be sealed of a component (not shown), for example a piston or a shaft or the like, in order to seal a liquid-conveying or fluid-conveying area. When the component is a moving component, the sealing body 1 is, for example, mounted with such an alignment that a relative movement of the surface to be sealed of the component towards the sliding surface 10 of the sealing body 1 extends in the shown direction.

Inside the sliding surface 10, a structure is formed, particularly a microstructure with cavities 2 that serve to generate a hydrostatic lubricating film towards a surface to be sealed of the component with a surrounding operating liquid. More precisely, the cavities 2 take up an operating liquid that is to be sealed against leakage via a sealing gap between the sliding surface 10 and the surface to be sealed. The received operating liquid is stored or held in the cavities due to capillary action thereof.

The cavity structure is complementary in a casting mould (not shown). The sealing bodies 1 with the microstructure are moulded in the moulding tool, i.e., manufactured in a primary shaping process in which the cavities 2 are provided by corresponding, knob-shaped projections in the casting mould during moulding.

The sealing body 1 is made of a viscoplastic material, for example, an elastomer having a hardness that, when using a measuring method with Shore A units, has a value of less than 100, preferably less than 90, for example, a value between 50 and 85 units, or the like in an equivalent measuring method with reference to the hardness of a material. When a directional component vertical to the plane of the sliding surface 10 exerts pressure on the cavities 2 due to a movement of the component (not shown), or shear forces act in the plane direction of the sliding surface 10 on remaining sections or ridges of the sealing body 1 between the cavities 2 due to stiction or sliding friction, the cavities 2 are deformed.

The deformation leads to the volumes of the cavities 2 being decreased, whereby a part of the capillarily held operating liquid is released into the sealing gap between the sliding surface 10 and the surface to be sealed of the component. Due to an unchanged or locally reduced gap dimension, a hydrostatic lubricating film is generated together with the released operating liquid between the sliding surface 10 and the surface to be sealed. A locally higher pressure provides for partially larger structural deformations of the cavities 2 and a correspondingly higher volume release of the operating liquid held therein, which contributes to the pressurization of the lubricating film. After a movement, the cavities 2 take up operating liquid again from the sealing gap in the larger volume of its reversible, original shape, which in turn causes a hydrostatic pressure to drop again and the lubricating film, or its temporary increase, decreases again.

The hydrostatic lubricating film lowers stiction and sliding friction between the sealing body 1 and the component, which makes the inventive sealing device particularly suited for hydraulically sealing linearly moveable or rotating components in applications in which easy running properties or high wear-resistance are preferred for durability and operational reliability.

The cavities 2 have an elongated shape with a longer dimension x and a shorter dimension y, the functional arrangement of which is uniformly aligned. The embodiment shown in FIG. 1 comprises cavities 2 of which the hollow parts are configured in the shape of elliptical semispheres, as may be seen in the contours at the sliding surface 10, which indicate an elliptic shape. All cavities 2 of the microstructure are arranged such that they are aligned in a common contour longitudinal direction X and a common contour transverse direction Y with respect to the longer dimension x and the shorter dimension y extending transversely thereto. It is advantageous that the arrangement of the cavities 2 be aligned such that the direction of the relative movement of the component extends vertically to the common contour longitudinal direction X, i.e., in the common contour transverse direction Y. A more sensitive deformation behaviour with respect to a direction component illustrated by the arrow B is thus used in order to achieve a better response of the hydrostatic pressurization as a result of the operating liquid released from the deformed cavities 2.

By arranging adjacent cavities 2 in an offset manner, a higher density of cavities 2 on the sliding surface 10 and a more consistent strength of the remaining portions or ridges therein between is realized.

FIG. 2 shows a second embodiment of a structure of cavities 2 in which they are split into two different groups of large elliptical cavities 2a and small elliptical cavities 2b. The large cavities 2a and the small cavities 2b of the two groups are in turn offset from one another and arranged alternatingly successively in such a way that parallel rows are formed with respect to the group of the large cavities 2a and the group of the small cavities 2b, both in the direction of the common cavity longitudinal dimension X of both groups as well as in the direction of the common cavity transverse direction Y of both groups.

By providing cavities 2a, 2b of different sizes and due to the deformation properties of the respective hollow parts resulting therefrom, a response of the hydrostatic lubricating film with respect to stiction and/or sliding friction may be set in a manner optimised for the application. Furthermore, a progression of change of the size of the sliding surface 10 and its friction with increasing depth of wear of the sealing body may be provided on the basis of the distribution and depths of the cavities, as may be seen in FIG. 3 B.

As an alternative to the shown structural pattern, more than two groups of different cavity sizes as well as a different arrangement or array of the different cavities 2 may be provided.

A third embodiment of a structural pattern is shown in FIG. 3, comprising both different cavity sizes and depths as well as different alignments of the elliptical contours with respect to the respective contour longitudinal direction and contour transverse direction. The structural pattern of the third embodiment enables an optimisation with respect to a surface roughness of the component to be sealed.

The frictional forces acting at the sliding surface 10 of the sealing body 1 may be subdivided into an adhesion component and a hysteresis component. The adhesion component, which also impacts stiction, may be attributed to static forming and rupturing of adhesive bonds between the elastomer and the component and depends on the surface size of the remaining sliding surface 10 between the cavities 2. The hysteresis component of a frictional force results from deformations of the elastomer which accompany an energy dissipation. The surface roughness of the surface to be sealed of the component, which correlates with a penetration depth or amplitude of local deformations at the sliding surface 10 of the sealing device, and a speed of the relative movement, which results from a frequency of occurrence or frequency of local deformations, cause stresses and relaxations at a contact surface.

An illustrative extreme case of this would be an edge or any other projection in the surface to be sealed of the component extending transversely to the relative movement. The brief immersion of such a counter contour into the cavities involves a steeper insertion in the contour transverse direction of an elliptical cavity than in the contour longitudinal direction, which may subsequently lead to higher frictional forces and increased wear to the point of a contour edge being sheared off. An angle between a contour transverse direction and the relative movement achieves a smoother insertion of the counter contour into and out of the elliptical contour of the cavity.

The illustrated structural pattern with elliptical contours in different alignments with respect to the relative movement of the component to be sealed achieves a distribution of the local elastic responsiveness to the stresses and relaxations at the remaining sliding surface 10 which may be set to an operating range of parameters specific for the application.

In an alternative development of the second and third embodiments, the structural pattern of cavities may be made up of both different sizes and different alignments of the contour.

FIG. 4 shows a fourth embodiment of a structural pattern on a rotationally symmetrical or cylindrical sealing body 1. In this embodiment, the shorter dimension y of the cavities 22 is constant over almost the entire longer dimension x. Thus, the shape on the sliding surface 10 is oblong instead of elliptical as in the first and second embodiment. All cavities 22 have the same shorter dimension y and are successively arranged on the laterally-shaped sliding surface 10 of the sealing body 1 in a common, spiral-shaped contour longitudinal direction X. A structural pattern is thus generated that is comparable to a thread divided by segments, the contour transverse direction Y of delimiting ridges of each cavity 22 corresponding to the external thread of a threaded bolt. Accordingly, the common contour longitudinal direction X does not extend orthogonally to the centre axis of the sealing body 1 but with a negligible inclination corresponding to a thread angle.

Alternatively, the illustrated arrangement may also be inverted such that the sliding surface 10 with the cavities 22 is arranged at an internal lateral surface of a rotationally symmetric sealing body 1, and a surface to be sealed is arranged at an external lateral surface of a cylindrical component.

In an alternative development of the fourth embodiment of FIG. 4, all cavities 22 are arranged with respect to their contour longitudinal direction X vertically to the centre axis of the sealing body 1, i.e., arranged with the contour transverse direction arranged towards the relative movement of the component. A structural pattern is thus generated in which annular progressions of cavities 22 are adjacent to one another in parallel along the centre axis of the sealing body 1.

The longer dimension x of the individual cavities 22 may be selected individually and differently. For example, similarly to the second embodiment, a succession of cavities 22 may be configured of groups having different dimensions x in contour longitudinal direction X in order to achieve different deformation behaviours due to the different aspect ratios, thereby making it possible to set a response of the hydrostatic lubricating film with respect to stiction and/or sliding friction optimised on the whole for the specific application.

In contrast to the illustration of FIG. 4, the structural pattern of the fourth embodiment and its alternative development may also be realized with cavities 22 of groups having different dimensions y in contour transverse direction Y and different alignments; different portions or ridges lying therein between thus achieve different deformation behaviours. In addition, the structural appearance of the third embodiment and its alternative developments may be realized with cavities 2 having an elliptical contour of the same or different sizes instead of cavities 22 or with a combination of cavities 22 in the shape of an elongated hole and elliptical cavities 2.

Conversely, the structural patterns of the first and second embodiments may be implemented with cavities 22 in the shape of elongated holes or in combination with the same.

1. A sealing device for hydraulically scaling surfaces on components which can be moved relative to one another in a translational or rotatory relative movement, comprising:
a viscoplastic sealing body with at least one sliding surface which is assigned to at least one scaling surface of one of the components; wherein
there is formed in the at least one sliding surface plurality of cavities which have closed contours, separated from one another, in relation to the sliding surface;
wherein
the contours of the cavities have a longer dimension (x) in a contour longitudinal direction (X) and a shorter dimension (y) in a contour transverse direction (Y).

2. The scaling device according to claim 1, the cavities having an elliptical contour.

3. The sealing device according to claim 2, the cavities being aligned in the direction of a relative movement of one of the components in relation to the contour transverse direction (Y).

4. The scaling device according to claim 3, cavities that are adjacent to one another in the contour transverse direction (Y) being configured to be offset from one another in the sliding surface in the contour longitudinal direction (X).

5. The scaling device according to claim 1, the sealing body having a rotationally symmetric shape, and the at least one sliding surface forming a lateral surface of the scaling body.

6. The sealing device according to claim 5, all of the cavities having a common contour longitudinal direction (X) which extends in a spiral shape in relation to a centre axis of the rotationally symmetric sealing body.

7. The scaling device according to claim 5, a plurality of radially circulating contour longitudinal directions (X) being arranged along a centre axis of the rotationally symmetric sealing body, and the cavities being formed distributed radially along the contour longitudinal directions (X).

8. The scaling device according to claim 1, the cavities differing from one another in relation to the alignment of the contour.

9. The sealing device according to claim 8, having at least two different groups of cavities with the same alignment of the contour.

10. The scaling device according to claim 1, the cavities differing from one another in relation to the dimensions (x, y) of the contour.

11. The scaling device according to claim 10, having at least two different groups of cavities with the same dimensions (x, y) of the contour.

12. The sealing device according to claim 1, the cavities having a depth of 10 to 40 μm in relation to the sliding surface.

13. The sealing device according to claim 1, the shorter dimension (y) in the contour transverse direction (Y) of the cavities having a maximum dimension of 15 to 200 μm.

14. The scaling device according to claim 1, a ratio of the longer dimension (x) in the contour longitudinal direction (X) to the shorter dimension (y) in the contour transverse direction (Y) being a value of 3 to 6.

15. The sealing device according to claim 1, the contours of the cavities being rounded at a transitional edge to the sliding surface.
